(19) United States
(12) Patent Application Publication
(10) Pub. No.: US 2010/0009325 A1
(43) Pub. Date: Jan. 14, 2010

(54) Psychological Testing or Teaching a Subject Using Subconscious Image Exposure

(75) Inventors: Boris G. Afanasiev, Moscow (RU); Egor V. Chernopyatov, Moscow (RU); Semyon V. Ioffe, Ottawa (CA); Igor K. Nezhdanov, Moscow (RU); Elena G. Rusalkina, Moscow (RU); Sergey V. Yesin, Moscow (RU)

Correspondence Address: DOWELL & DOWELL P.C., 103 Oronoco St., Suite 220, Alexandria, VA, 22314, US

(73) Assignee: IVS PSYCHOTECHNOLOGIES CORPORATION, Wilmington (new Castle County), DE (US)

(21) Appl. No.: 12/225,068

(22) PCT Filed: Mar. 13, 2006
(86) PCT No.: PCT/US2006/008885

§ 371 Date: Sep. 18, 2009

(51) Int. Cl. G09B 19/00

(52) U.S. Cl. 434/236

(57) ABSTRACT

The present invention relates to a psychological method for testing or subconsciously teaching a subject. The method involves varying a subconscious exposure time period of a visual subconscious stimulus displayed to a subject in order to determine an effective subconscious exposure time period specific to the subject. To subconsciously test the subject, the method further uses a masking stimulus following the visual subconscious stimulus, both images having common image characteristics including brightness and contrast. The masking stimulus is made from scrambled subcomponents of the visual subconscious stimulus. The invention also describes an apparatus for psychological testing capable of varying a subconscious exposure time period of a visual subconscious stimulus displayed to a subject in order to determine an effective subconscious exposure time period specific to the subject. The apparatus also uses a mosaic generator to generate a masking stimulus from a visual subconscious stimulus.

### FIELD OF THE INVENTION

The present invention generally relates to the field of psychological testing of a subject as well as to subconscious teaching. More specifically, the invention relates to a method of testing the state of psychic activity of a subject's mind and to reveal latent and/or unconscious information contained in the mind. Considering that even with the development of modern technologies the human factor still represents an increasing value in many spheres of activity, the present invention may find application in medical and in a psychoanalytical practices, in human resources services, security services, schools, marketing research just to name a few.

### BACKGROUND OF THE INVENTION

All organizations rely heavily on the psychologically well-being, integrity, loyalty and dedication of their members for their health and success. The cost to organizations resulting from a lack of these psychological qualities is huge. Assessing and monitoring these psychological qualities of individual members of an organization is thus of paramount importance, however, it remains complex, expensive and unreliable. As a result, assessing and monitoring is either poorly implemented or not done at all. If a technique for assessing and monitoring these psychological qualities is not very highly reliable, organizations are very likely to reject its use, since a false positive has very negative emotional consequences for the individual, while a false negative has negative consequences for the organization.

Nowadays, computers have the ability to allow us to analyze the fast flowing subconscious mental processes in real time, revealing the nucleus of the human personality, enabling us to reveal factors that have influenced its formation and defining its actual status. A number of computer technologies for psychological testing of humans are known. These technologies measure individual reactions of a human personality to verbal (i.e. word) stimuli. For example, U.S. Pat. No. 4,699,153, U.S. Pat. No. 5,327,899, RU2125399 and U.S. Pat. No. 5,299,118 disclose methods involving the presentation to a subject of a series of control, relevant and neutral questions, the recording of physiological reactions and the analysis of the results. However, all of these patented methods do not allow us to learn about real buried content of mental activity that is substantially defined by the content of the subconscious spheres of psyche of the subject being tested. Because the information used for the test is accessible to the conscious mind, and therefore under its influence, the reactions of the subject being tested may knowingly or unknowingly change.

Smirnov et al. published in their book (Psychotechnologies: Computer psycho-semantic analysis and psycho-correction at subconscious level, Smirnov I. V. et al., Progress, 1995, pages 125 to 224) a method illustrating a direct mode of inputting test information without distortion into a semantic zone of memory under investigation. This method excludes the criticism of modulating influences from the conscious mind and allows obtaining untainted reactions from the subject. Based on his method, the same author was granted patent RU2218867.

This patent discloses a method using a database consisting of four functional group containing semantic stimuli in the form of images representing words. Stimuli are shown in the conscious and subconscious states. A masker is superimposed over the subconscious stimuli immediately after exposure of the subconscious stimuli. Rows of numbers are used as the masker. Thus, the sets of words subconsciously displayed include reinforcement words, words close in meaning but having a different level of semantic categorization, visually close words, words both different in meaning and in appearance, neutral words, taboo words, and words from the area of nuclear structures of the personality.

The exposure time of the test stimulus is 16 milliseconds while the masker is exposed during 510 milliseconds. The intervals between presentations are measured from the time of the previous reaction from the subject to the start of the next presentation. The intervals between presentations are changed in a random fashion and the intervals are calculated as the time of the previous reaction with the addition to it of a random variable in a range of 1-350 ms. According to the instructions given, the subject should press the trigger as quickly as possible in reply to each meaningless word displayed as the masker. On the other hand, upon being presented meaningful words, which are randomly inserted among the meaningless words, the subject should not press the trigger. When mistakes are made, the range for the types of mistakes is stipulated. Both visual-motor reaction and/or recording of physiological reaction parameters are used to define the reaction time. The statistical analysis of the results for each separate subject is finally performed.

Although generally yielding good results, this method does not consistently provide reliable results. Indeed, during tests using this method, some subjects had the ability to recognize the subconscious stimulus shown for the 16 ms exposure time. These subjects are often specially trained persons or persons whose work require quick reflexes. Amongst others, there would be special force employees, programmers, computer games buffs, racecar drivers, etc. Hence, the aforementioned method may not be universally used with very good reliability.

Furthermore, these methods do not take into account the age difference between subjects. Indeed, a younger subject may be more rapid to react than an older one. Generally speaking, these methods do not take into account the specific profile of the subject.

All of the methods described here above use words as subconscious stimuli. This may create a problem, as some words may not be readily recognized by some subjects, especially if the subject is weak at reading. This further decreases the reliability of the method. Furthermore, the use of words is rather limitative as it is difficult to express some complex situations in just one or two words.

There is therefore a need for a new approach to psychologically testing a subject that allows increasing the quantity of information obtained from the subject, the reliability of the results and the quantity of characteristics obtained about the personality of the subject and about his/her psycho-emotional state.

In the case of teaching a subject using subconscious images, improvement of the psychological condition of an individual is possible. An improvement in the psychologically well-being, integrity, loyalty and dedication of individual members of an organization can be of considerable benefit to the health and success of the organization.

### SUMMARY OF THE INVENTION

It is an object of the present invention to provide an apparatus and a method of psychological testing or subconsciously teaching a subject that overcomes one or more of the above drawbacks.

It is another object of the present invention to provide an apparatus and a method of psychological testing or subconsciously teaching a subject that does not require the subject to read stimuli.

It is another object of the present invention to provide an apparatus and a method of psychological testing or subconsciously teaching a subject that prevents conscious stimuli from being recognized from subconscious stimuli when using images as stimuli.

It is another object of the present invention to provide an apparatus and a method of psychological testing or subconsciously teaching a subject that maximizes the subject's reaction to stimuli.

In a broad aspect, the invention provides a method of psychologically testing or subconsciously teaching a subject comprising the step of exposing the subject to an effective number of visual subconscious stimuli, same or different, displayed at different subconscious exposure time periods. The different subconscious exposure time periods permit greater efficiency of testing or teaching than a single subconscious exposure time period. While analysis of responses to a variety of subconscious exposure time periods may allow for the benefit of more effective time periods to be gained by proper weighting, it is advantageous to determine a desired effective subconscious exposure time period and then use such time period for testing or teaching. This determination can be by a subject's profile, such as age and habituation in daily life to activities that require quick mental reflexes like playing video games, certain sports, race car or taxi driving, to determine a better “profile group average” estimated exposure time for the subject's profile, or the method may further comprise the steps of determining a reaction of the subject to the visual subconscious stimuli and analyzing the subject's reaction to the visual subconscious stimuli to determine a desired effective subconscious exposure time period specific to the subject. Optionally, the method may combine both the use of a profile and measurement of the subject to determine the desired effective subconscious exposure time period. Knowing the profile can reduce the testing time to find the desired exposure time period, since certain portions of the whole suitable range for all subjects may be eliminated based on profile.

More preferably, the method comprises the step of exposing the subject to additional visual subconscious stimuli, same or different, displayed at the effective subconscious exposure time period for the remainder of the psychologically testing or subconscious teaching. It is possible to repeat the method with a second subject. In this case, the effective subconscious exposure time period may be different for both subjects. Typically, the different subconscious exposure time periods will comprise at least five periods in the range of 9 ms to 25 ms.

Preferably, the effective subconscious exposure time period is determined to maximize the subject's reaction. It will be appreciated that the desired subconscious exposure time period is best selected to avoid detection of the subconscious image by the conscious mind, namely too long, while being long enough to enable a reaction in the subconscious mind. The reaction is typically determined by comparing the subjects response to subconscious visual stimuli having a high semantic load with subject's response to subconscious visual stimuli having a low semantic load. It is possible that the subconscious visual stimuli having a low semantic load have essentially no semantic load. Reaction to subconscious stimuli varies for each subject over time, possibly as a function of the emotional or mental state of the subject. Thus the reaction to subconscious stimuli is different during a testing period, however, this variation is typically negligible over several seconds during which the emotional or mental state is not likely vary significantly. The comparison of reaction to high semantic load stimuli with temporally close control or low semantic load stimuli is thus effective to measure reaction to high semantic load subconscious stimuli.

Measurement of reaction can be achieved in a variety of ways. One modality is to use electro-encephalography (EEG). Preferably, the subject's reaction is determined by measuring a deviation in the subject's voluntary response time to a conscious stimulus as a function of exposing the subject to the subconscious visual stimuli prior to displaying the conscious stimuli. This may be likened to playing a video game (and in fact could be a standard video game), although it may be greatly simplified to be suitable for subjects not accustomed to playing video games. An environment in which the subject maintains a relatively relaxed state while remaining consciously focussed on, or occupied with, an interactive test or game allows for efficient testing. The conscious stimulus contains visual information for the subjects analysis to indicate a type of suitable voluntary response. The reaction is determined by the response time deviation and by errors in the suitable voluntary response made by the subject. The deviations and errors can be expected to be highly correlated with the subconscious stimuli.

The efficacy of testing and teaching using subconscious visual stimuli is improved when the conscious mind is not disturbed or “aware” of the subconscious stimuli. In addition to prolonged exposure time leading to such awareness, the human visual system may be stimulated to have such awareness when the subconscious visual stimulus contrasts in brightness and hue with respect to the following conscious display, whether a blank screen, a background image, or a conscious stimulus. Preferably, the method comprises the step of masking the visual subconscious stimuli with a masking stimulus. The visual subconscious stimulus and the masking stimulus have substantially similar image characteristics comprising brightness and contrast. In the case that the masking stimulus does not contain information for the subject, the masking stimulus may be a scrambled or mosaic version of the subconscious stimulus. However, when the masking stimulus must contain information, more moderate adjustments to the conscious stimulus image, such as color composition and brightness, are in order to reduce the brightness and hue contrast.

Optionally, the method further comprises the steps of selecting the visual subconscious stimulus from a group of subconscious stimuli and selecting the masking stimulus from a group of masking stimuli. The group of subconscious stimuli and the group of masking stimuli are contained in a database. However, preferably, the masking stimulus is a scrambled version of the visual subconscious stimulus. More preferably, the masking stimulus consists essentially of a plurality of subcomponents of the visual subconscious stimulus. The plurality of subcomponents is arranged randomly such as to create a mosaic.

Preferably, the step of exposing comprises adjusting the subconscious exposure time period by varying a refresh rate of an electronic display and displaying the visual subconscious stimulus for at least one field or frame of the electronic display. Many conventional CRT and flat panel displays have selectable refresh rate modes that can allow small changes to refresh rates. This can be used to make small increments in exposure time of an image displayed for an integral number of fields or frames. Optionally, the step of exposing is done by varying a number of fields or frames during which the visual subconscious stimulus is displayed on the electronic display operating at a refresh rate of at least 200 Hz. Preferably, the subconscious exposure time period ranges between 5 milliseconds and 50 milliseconds. It will be appreciated that specially adapted display systems can be used to provide the projection or display of subconscious visual stimuli. For example, in an image projection system, a flash lamp can be used instead of a continuous lamp controlled to project the image for a desired time that may be any fraction of a whole field or frame of a conventional display. The conscious image can then be provided by a separate projector or display system in superposition with the subconscious image projection.

In another broad aspect, the invention provides a method of psychologically testing or subconsciously teaching a subject comprising the step of exposing the subject to a masking stimulus following a visual subconscious stimulus in order to determine a reaction from the subject. The visual subconscious stimulus and the masking stimulus have substantially similar image characteristics comprising brightness and contrast. Preferably, the masking stimulus is a scrambled version of the visual subconscious stimulus. More preferably, the masking stimulus consists essentially of a plurality of subcomponents from the visual subconscious stimulus. The subcomponents are arranged randomly. Most preferably, the subcomponents are further individually randomly rotated.

Preferably, subcomponents are of regular geometric shapes. The use of hexahedrons is recommended. These hexahedrons may individually randomly be rotated by multiples of 60 degrees.

Optionally, the visual subconscious stimuli are selected from a group of test stimuli bearing particular meaning contained in a database. The masking stimuli are selected from a group of control test stimuli bearing no particular meaning contained in the database. The database further contains a group of non-testing stimuli adapted for maintaining a necessary level of operator readiness and a group of testing stimuli adapted to assess the significance of the anxiety level to test stimuli of the subject being tested. Intervals between presentations may be changed in a random fashion and calculated as the time of the previous reaction with the addition to it of a random variable in a range of 1-350 ms.

According to another broad aspect, the invention provides a mistake which is attributed to the reaction if the reaction was not expected according to a set of rules of the testing method. The reaction of the subject is a sensory-motor reaction. The mistake is classified into one of different types of mistakes for determining a psycho-emotional state and personal characteristics of the subject.

Preferably, the method further comprises the steps of exposing the subject to a second masking stimulus, same or different from the masking stimulus, following a second visual subconscious stimulus, same or different from the visual subconscious stimulus and analyzing the subject's reaction to the visual subconscious stimulus to determine an effective subconscious exposure time period specific to the subject.

In another broad aspect, the invention provides an apparatus for psychologically testing a subject. The apparatus comprises a controller, a display, a reaction measurement unit and a calculator. The controller is operative to send at least two visual subconscious stimuli at different subconscious exposure time periods to a display. The display is connected to the controller and is operative to display the visual subconscious stimuli to the subject. The reaction measurement unit is operative to determine the subject's reaction to the visual subconscious stimuli. The calculator is connected to the reaction measurement unit and determines the effective subconscious exposure time period specific to the subject. Preferably, a response analyzer is used to compare the reactions to the display of the visual subconscious stimuli having a low semantic load with the visual subconscious stimuli having a high semantic load. Preferably, the calculator determines the effective subconscious exposure time period to maximize the reaction. The reaction may be a response time.

A database containing a group of subconscious stimuli and a group of masking stimuli may also be part of the apparatus. Preferably, a mosaic generator is also used in the apparatus. The mosaic generator generates a masking stimulus from each of the visual subconscious stimuli. The visual subconscious stimulus and the masking stimulus have substantially similar image characteristics comprising brightness and contrast. Preferably, the masking stimulus is a scrambled version of the visual subconscious stimulus. More preferably, the mosaic generator generates the masking stimulus by decomposing the visual subconscious stimulus in a plurality of subcomponents which are arranged randomly.

In another aspect, the invention provides a system for psychologically testing or subconsciously teaching a subject. The apparatus comprises a controller, a display and a reaction measurement unit. The controller sends the masking stimulus and the visual subconscious stimulus to a display. The display is connected to the controller and displays the visual subconscious stimulus and the masking stimulus to the subject. The reaction measurement unit determines the subject's reaction to the visual subconscious stimulus.

The visual subconscious stimulus and the masking stimulus have substantially similar image characteristics comprising brightness and contrast. Preferably, the masking stimulus is a scrambled version of the visual subconscious stimulus. More preferably, the mosaic generator generates the masking stimulus by decomposing the visual subconscious stimulus in a plurality of subcomponents. The subcomponents are arranged randomly.

Optionally, the apparatus may further comprise a calculator that determines an effective subconscious exposure time period specific to the subject.

In another broad aspect, the invention provides an apparatus for psychologically testing a subject. The apparatus comprises a controller, a display, a reaction measurement unit and a response analyzer. The controller sends a masking stimulus and a visual subconscious stimulus to a display. The subject reacts to the visual subconscious stimulus and the reaction measurement unit determines the subject's reaction to the visual subconscious stimulus. The response analyzer evaluates the errors in a suitable voluntary response made by the subject and determines an indication of a degree of fitness to respond under psychological stress for the subject.

In yet another broad aspect, the invention provides a method of psychologically testing a subject. The method uses measurement of a deviation in the subject's voluntary response time to a conscious stimulus as a function of exposing the subject to a subconscious visual stimulus. The conscious stimulus contains visual information for the subject's analysis to indicate a type of suitable voluntary response. The reaction is determined by the response time deviation and by errors in the suitable voluntary response made by the subject. Evaluating the errors allows determining an indication of a degree of fitness to respond under psychological stress for the subject. Preferably, the errors are weighted more for errors made following a visual subconscious stimulus having low semantic load.

Advantageously, the present invention provides a method of psychologically testing or subconsciously teaching a subject that increases the quantity of information obtained from the subject, increases the reliability of the results and increases the quantity of characteristics obtained about the personality of the subject and about his/her psycho-emotional state. These improvements are achieved by using additional stimuli in the form of images. This allows the involvement of various representative channels of perception and processing of the information, increasing the wealth of information obtained from the subject. The use of scrambled masking stimuli substantially similar to the visual subconscious stimuli makes it possible to use such images as visual subconscious stimuli. Moreover, by using stimuli with an exposition time that is maximized and specific for each subject, it is possible to exclude the possibility that the subject consciously realizes what the subconscious stimulus is, hence greatly increasing the reliability of the test.

### BRIEF DESCRIPTION OF THE DRAWINGS

These and other features of the present invention will become more apparent from the following description in which reference is made to the appended drawings wherein:

FIG. 1 shows a block diagram of the apparatus for psychological testing and subconscious teaching according to an embodiment of the present invention.

FIG. 2 shows a graph depicting a typical reaction level of a subject as a function of the subconscious exposure time period.

FIG. 3 shows a block diagram of the apparatus for psychological testing and subconscious teaching according to another embodiment of the present invention.

FIG. 4 shows a table used for analyzing the mistakes made by a subject according to another embodiment of the present invention.

FIGS. 5 and 6 show an example of testing report according to another embodiment of the present invention.

FIG. 7 show a table representing an example of the groups of subjects being tested and the techniques used.

### DETAILED DESCRIPTION OF EMBODIMENTS

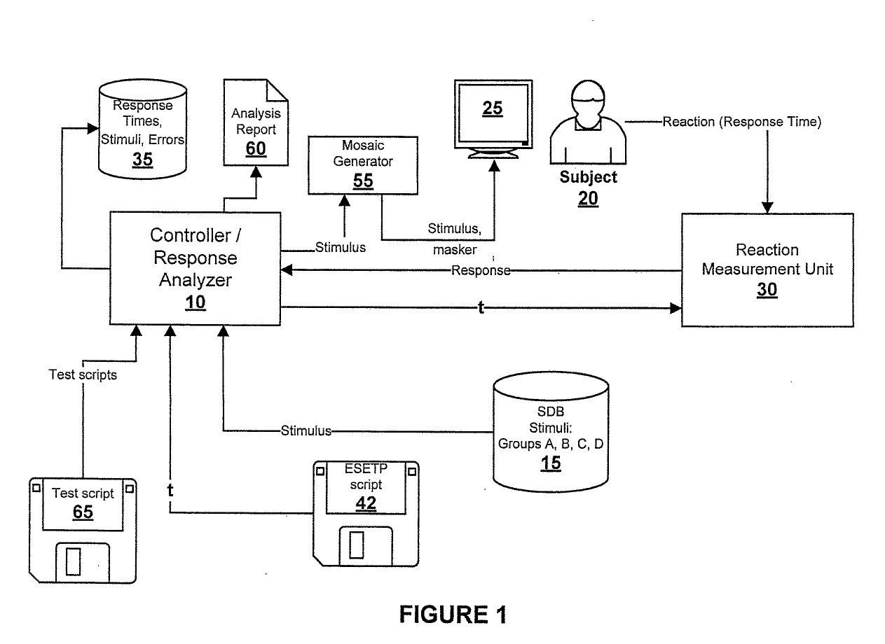

FIG. 1 shows a block diagram of an example of the invention. A controller/response analyzer 10 is used to manage the test. It is possible to use a computer as a controller/analyzer. A semantic database (SDB) 15 contains stimuli in the form of both words and graphic images. Words come from generally accepted, slang, professional and other dictionaries of any language. From this SDB 15, individually adapted sub-databases, called semantic topics, may be built according to specific information about the subject. Each semantic topic is tested using a set of synonyms of the stimuli. The synonyms consist of words and images that are close and semantically connected among themselves. In the SDB 15, the stimuli are distributed into four functional groups:
Group A: A group of control testing stimuli. The stimuli of this group do not bear any semantic load (for example: it can be rows of numbers, a set of consonants or maskers).
Group B: A group of test stimuli. This group contains meaningful words belonging to any language and images bearing semantic load.
Group C: A group of non-testing stimuli. The stimuli of this group are presented for maintaining a necessary level of operator readiness and the development of conditional defensive reaction.
Group D: A group of test stimuli. These stimuli are used to find the significance of the level of the subject's anxiety from being presented the test stimuli of Group C where mistake were potentially made.

The controller/analyzer 10 selects a stimulus in one of the groups contained in the SDB 15 which will be shown to a subject 20 using a screen 25. The controller/analyzer decides the time t during which the stimulus will be displayed on the screen 25. Stimuli of Groups A, B and D are always shown in a masked mode, (that is the stimuli are shown for a very short period of time corresponding to a subconscious time period and are quickly covered or masked by another image or row of random numbers) which means that on its occurrence on the screen, the subject should have time to react (to press a trigger, for example). Stimuli of Group C are shown both in masked and unmasked mode (the stimuli is shown but not masked by another image or row of random numbers). In the unmasked mode, the stimulus is shown for a longer period of time such that the subject 20 may distinguish what the image is. During the presentation of stimuli in the unmasked mode the reaction of the subject should be differentiated. That can be accomplished by using, for example, a trial and error method to define whether the subject reacts to the stimulus or not. Reactions of the subject 20 to the stimulus are monitored by a reaction measurement unit 30. The reaction measurement unit 30 monitors sensory-motor reactions of the subject 20. For example, the subject 20 could have to press a trigger to provide his reaction. The response is fed back from the reaction measurement unit 30 to the controller/analyzer 10 which sequentially stores in the database 35 all information regarding which stimulus was displayed, the subject response to the stimulus and any eventual error.

When a stimulus is shown in the form of a word, a sequence of 15 random numbers (except 0 and 1) is typically used as a masker. This sequence blocks all area of the stimulus shown. Each sequence of numbers is different. The exposure time of the masker typically ranges from 300 to 500 milliseconds (ms).

In some situations, it is advantageous to display an image as a stimulus instead of a word. However, when so doing, it is not possible to use a sequence of numbers as a masker otherwise the subject 20 would notice that an image was flashed before his eyes. When an image is used as the stimulus, it is shown such that it completely fills the screen. In order to mask the image used as a stimulus, another image not bearing any semantic load is used as a masker. However, if both images do not have the same image characteristics such as, for example, brightness and contrast, the subject may still be able to recognize that a different image was shown as a stimulus. Hence, a masking image having substantially similar image characteristics as the stimulus must be used. The masking image, or masker, may be either selected from a bank of images contained in a database, or preferably, generated directly from the image shown as a stimulus. Hence, a mosaic generator 55 is used to generate a mosaic which is used as a masker when the stimulus is an image. This mosaic is obtained from the initial image used as a stimulus so that it retains important image characteristics such as brightness and contrast. The mosaic is generated by first fragmenting the stimulus in many small sub-elements. These sub-elements are of a regular geometric shape. Many different shapes may be used, but hexahedrons are preferably used. These hexahedrons may also be of various sizes. Then, each hexahedron is randomly rotated around its normal axis by a multiple of 60 degrees, or in other words, by an angle of 60, 120, 180, 240 or 360 degrees. As a result, the mosaic is composed of a plurality of sub-elements of the stimulus, each sub-element being randomly rotated around its own normal axis by an angle that is a multiple of 60 degrees. For better certainty, the mosaic generator 55 may repeat the operation two or more times, starting with the last generated mosaic, by using hexahedrons of a different diameter from the previous time. For example, hexahedrons may have an external diameter of 60 pixels the first time and 50 and 24 pixels for respectively the second and third times.

As a result, the masker has the exact same information as the stimulus, but scrambled. Because important image characteristics such as brightness, contrast and composite components remain the same, it is impossible for the subject 20 to recognize the stimulus. During the test, the mosaics are used as maskers to cover image stimuli displayed to the subject unconsciously. An image stimulus is displayed to the subject for a subconscious exposure time period and once this period has elapsed, is replaced, or masked, by a masker. The masker may either be a completely different image having the same image characteristics as the stimulus or, more conveniently, be generated from the stimulus (the initial image) as explained here above. Using a mosaic ensures that the masker has the same image characteristics as the stimulus. Advantageously, since the information of the stimulus remained the same in the mosaic, except that it is scrambled, the subject being tested does not realize that a different stimulus was imposed on him subconsciously before the mosaic was displayed over the stimulus. Indeed, when the mosaic is superimposed over the stimulus during the procedure, only the mosaic is subjectively realized consciously by the subject. However, the subject realized the stimulus only subconsciously because it was shown for a very short period of time. The mosaic completely covers the space occupied by the stimulus during the test.

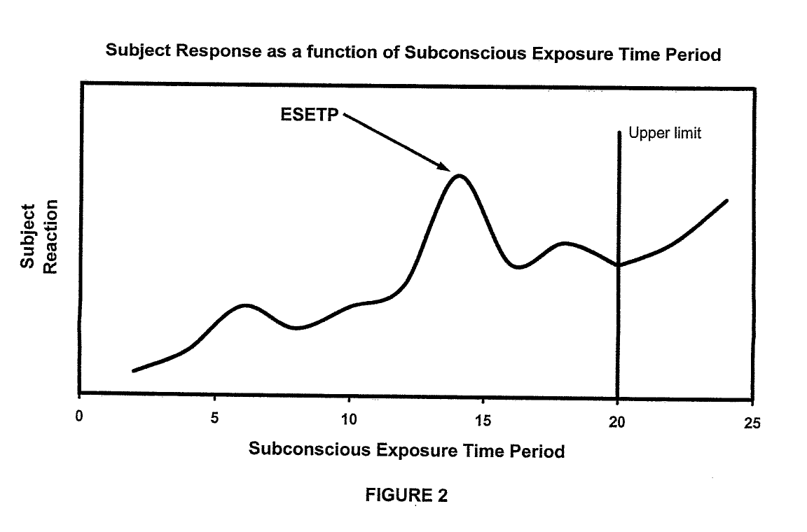

Images or words may be used as visual subconscious stimuli. These visual subconscious stimuli are shown during a very short period of time such that the conscious part of the brain does not recognize what was shown, while the subconscious does. Traditionally, this very short period of time, called the subconscious exposure time period, was set to a value of approximately 15 ms. However, it has been discovered that not all subjects have the same optimal subconscious time period. Indeed, this time period varies from a subject to another. This time period corresponds to the subconscious time period where a subject shows the largest measured reaction. FIG. 2 shows a typical response of a subject as a function of the subconscious exposure time period. We can see that in this example, there is a peak in the reaction of the subject 20 around 14 ms. The subject reaction also start increasing steadily above 20 ms. However, at that exposure time period, the subject 20 starts realizing consciously the stimulus which is way he/she has a larger reaction. Therefore, an upper limit must be drawn and the peak reaction below the upper limit is the effective subconscious exposure time period (ESETP).

The use of a standard subconscious exposure time period may impair the reliability of the test. Indeed, at such a standard subconscious time period, there are some subjects that can consciously recognize the stimuli, therefore being capable to consciously alter their reaction. By determining the most effective subconscious time period particular to each subject, it is possible not only to improve the influence of the subconscious stimuli on the subject, but also to prevent a subject from consciously recognizing subconscious stimuli.

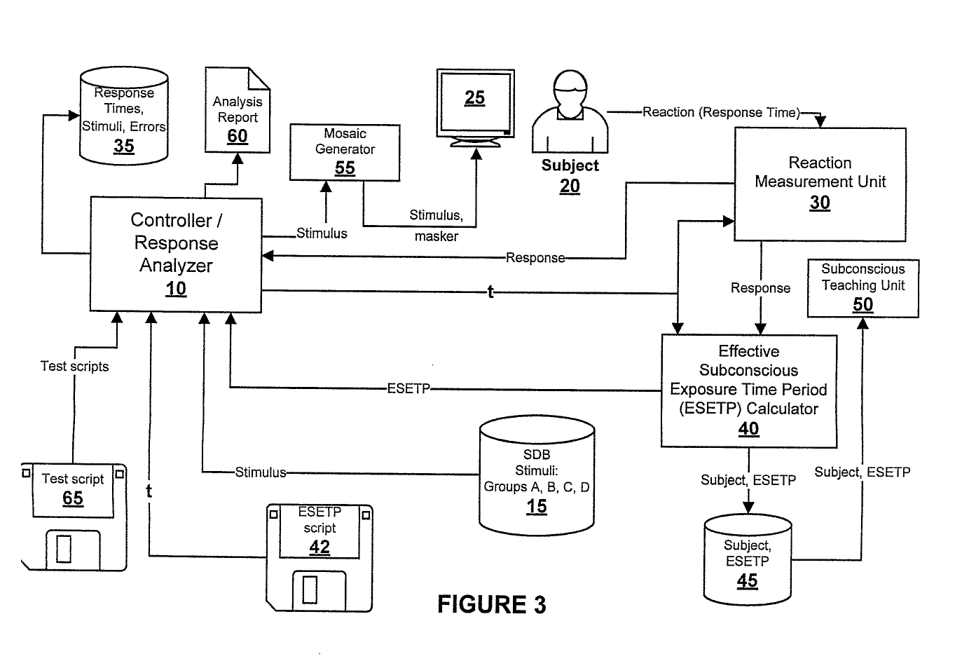

The first step in a psycho-probing test is therefore to determine the most effective subconscious exposure time period for a subject being tested. FIG. 3 shows a block diagram of another example of the invention. In this example, an effective subconscious exposure time period calculator (ESETP calculator) 40 is used in combination with an ESETP script contained in memory 42. Instead of using a standard subconscious exposure time period, the controller/analyzer 10 uses the ESETP script to find the effective subconscious exposure time period for the particular subject 20 to be tested. This step is achieved experimentally for each subject. For this purpose, the controller/analyzer 10 displays stimuli with different exposure times varying from 5 ms up to 50 ms. Preferably, steps of 5 ms are used.

Advantageously, because the controller/response analyzer used is capable of being programmed with different test scripts 65 it is possible to administer different tests using the same controller/response analyzer.

The subject 20 is shown a stimulus for a subconscious exposure time period t which is immediately followed by a masker. The subject 20 is asked to react depending on the masker shown. This is done many time, typically 30 times, at various subconscious exposure time periods. The reactions of the subject 20 are sent to both the controller/response analyzer 10, which registers them in database 35, and the ESETP calculator 40, which processes them to determine the most effective subconscious exposure time period for this particular subject. Once the ESETP calculator 40 has received enough information to calculate the ESETP, it feeds it to the controller/analyzer 10 which uses this value of the effective subconscious exposure time period for the rest of the test with this particular subject 20.

This determination of the most effective subconscious time period of a subject may be performed as a standalone test, or may be carried out as an integral part of a test to psychologically assess a subject as described here above. Indeed, the ESETP calculator stores in memory 45 the information about the subject 20 and his effective subconscious exposure time period for a later use. Hence, either the effective subconscious exposure time period is inputted manually at the beginning of a psychological test, and this value is used for testing the subject, or the test is designed to automatically analyze the reactions of the subject 20 at different subconscious exposure time periods and adjust itself to use the effective subconscious exposure time period for the subject being tested for the remaining of the test.

Advantageously, this effective subconscious exposure time period for a particular subject 20 may be retrieved from memory 45 and used in subconsciously teaching, of the subject 20. This is shown as subconscious teaching unit 50. It has been found that by using the effective subconscious exposure time period for a particular subject 20 increased by much the efficiency of the teaching or the reliability of the psychological test.

Displays of stimuli are separated by a random time interval so that the subject does not anticipate a timing for response independent of the stimulus. The time interval between stimuli is calculated as the sum of the subject response time to a first stimulus and a random time period. Hence, the more quickly the subject reacts, the shorter is the delay. However, the delay should never be less than 200 ms or more than 500 ms. The random time period added to the response time varies between 0 and 350 ms. The introduction of a random time interval between stimuli forces the subject to concentrate on the test and prevents him from rhythmically pressing a trigger.

It is important to consider that different people have different psycho-physiologic processing speeds, depending from their profile. Consequently, the pace at which a subject 20 proceeds in a test is specific. To compensate for that disparity, the test contains an algorithm for the presentation of stimuli that adjusts itself empirically. For example, if the subject made more than two mistakes during the presentation of a set of 15 stimuli, the level of complexity is reduced by one unit. This is then reflected by a low tone of an acoustic signal heard by the subject Conversely, if the subject 20 made less than two mistakes, the level of complexity is increased by one unit, which would be reflected by a high tone of the acoustic signal. Therefore, the test is adapted to the pace of the subject 20 by adjusting the level of complexity.

The mistakes made by the subject during testing are classified depending on their types:
Type 1: ERR_EARLY: The subject reacted before the stimulus appeared, or earlier than 100 ms after its presentation;
Type 2: ERR_INVAIN: The subject reacted when the stimulus appeared, but the stimulus did not require the trigger to be pressed;
Type 3: ERR_LATE: The subject did not react within 1000 ms after the presentation of a stimulus for which he was required to press the trigger;

Mistakes 1 to 3 are corroborated with a vocal message, a sound signal (the signal for each type of mistake being different) and a visual text note on a red background. When a mistake of type 2 occurs, the stimulus for which the mistake was made is shown again immediately after the sound and the display of the text underlining the mistake. The stimulus is repeated to obtain the necessary response. When mistakes of type 1 or 3 occur, the stimulus for which the mistake was made is recorded sequentially into a queue. The stimuli from this queue are shown upon termination of the set of test stimuli.

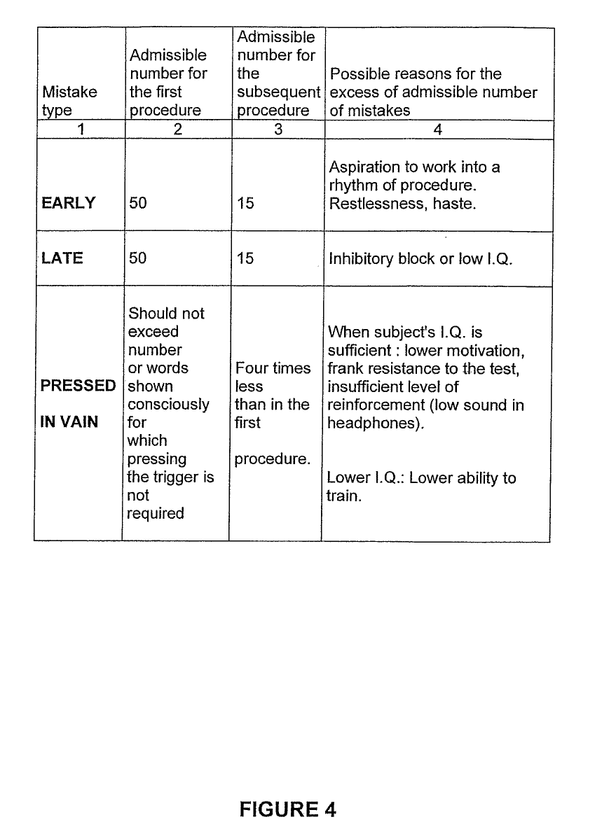

Referring now to FIG. 4, the analysis of mistakes made by subject 20 will be detailed.

Within the limits of normal values:

1. If the “EARLY” number of mistakes is more than the “LATE”, it corresponds to a sufficient level of wakefulness, readiness to adapt to stressful situations, high level of activity, ability to creatively optimize activity and a good ability to learn.

2. If the “LATE” number of mistakes is more than the “EARLY”, it corresponds to carefulness in decision-making, dependence on the opinion of associates, conscientiousness and high working capacity during conditions of monotonous work.

The procedure of psycho-probing is conducted on a separate computer in a darkened area, where distracting visual and acoustic factors are excluded. The subject 20 is placed in a chair with armrests 1 to 1.5 meters from the screen 25 with his/her eyes centered on the screen 25. The subject 20 should directly face the screen 25. The thumb of the preferred hand should be on the trigger (not shown). The subject 20 puts on the closed type of headphones which are connected to a sound card in the computer.

Before beginning the psycho-probing test, instructions appear on the screen. The instructions are duplicated by a voice in the headphones. The instructions to the subject are simple: on the screen, rows of numbers and mosaic images will quickly flash and he/she has to press the trigger as soon as possible. Periodically on the screen, words or images belonging to two different groups of meaning will appear, and the subject is required to press the trigger when the words or images of one group appear. Conversely, he/she should not press when the words or images of the other group appear. Using the trial and error method, the subject finds which words require reactions and which do not. Each mistake is accompanied by a loud unpleasant acoustic signal and a corresponding remark on the screen.

Once the instructions are finished, the test procedure begins. All stimuli contained in the SDB are sequentially displayed on the screen, either in the masked or unmasked modes. Each stimuli and the time of the corresponding response from the subject is recorded. The response time is calculated from the moment of the presentation of the stimulus until the moment the reaction of the subject is recorded. This moment may be when the subject presses a trigger, for example. The mistakes are also registered in the sequence they are made.

A required level of operator motivation is sustained by unmasked stimuli included in the database. According to the instructions that the subject was given, he/she is forbidden to react when these stimuli appear on the screen. Reacting to the presentation of such stimuli or, conversely, not reacting when it is necessary to react, leads to strong unpleasant sound signals in the subject's headphones. It is impossible for the subject to foresee the occurrence of unmasked stimuli as their sequence is random and the motivation to avoid negative reinforcement, in the headphones and on the screen) forces the subject to closely watch the events on the monitor. Besides, different time intervals between the presentations of the stimuli do not allow the subject to rhythmically press the trigger. Thus, inevitably there are mistakes such as ERR-EARLY or ERR_LATE. Therefore, a close tracking of the screen leads the subject to look at each stimulus.

All data, i.e. stimuli and response times and mistakes is sequentially recorded during testing. The test procedure is complete once the subject has fulfilled all the stimuli from the SDB. Subsequently, stimuli and response times are grouped according to their stimuli group, and mistakes are grouped according to their types. All this data is processed at once after the procedure ended. To increase the reliability of the method, only the data where the subject reacted without mistake to the stimuli is processed statistically to determine the results of the test.

Measurements data of stimuli groups are compared to a control group. Comparisons may be done with nonparametric methods of statistical processing. For example, the Mann-Whitney statistical criteria at a significance level of 0.05 may be used.

The following algorithm of calculation can be used:
1. Groups are united and members of the groups are organized in increasing order of value;
2. Each value is given an appropriate rank: 1—smaller, etc. If values coincide, the same average rank is assigned to both of them (if two identical values occupy place 3 and 4, then rank of 3.5 is given to both);
3. For a smaller group, T—the sum of all ranks of its members is calculated;
4. The average μ_{T} of all T values is calculated:

$${μ}_{T} = \frac{{n}_{i} ( {n}_{i} + {n}_{λ} + 1 )}{2}$$

Where: nM and nE are respectively the total number of members for small and large samples.
5. The standard deviation is calculated:

$${σ}_{T} = \sqrt{\frac{{n}_{M} {n}_{λ} ( N + 1 )}{12} - \frac{{n}_{M} {n}_{λ}}{12 N ( {N}^{2} - 1 )} \sum ( {τ}_{i} - 1 ) {τ}_{i} ( {τ}_{i} + 1 )}$$

Where N=nM+nE and where τᵢ is the number of values of i-rank (in which values coincide). The summation is made on all coinciding ranks. If there are no coinciding values in the sample, everything that goes after a minus value is not considered.
6. ξ_{T} is calculated;

$${ζ}_{T} = \frac{\vert T - {μ}_{T} \vert - \frac{1}{2}}{{σ}_{T}}$$

7. ξ_{T} is compared to the critical values of normal distribution for the infinite number of degrees of freedom at a significance value of 0.05.

If the criteria exceed the critical value, it is considered that the given semantic group has a high subjective significance. The “sign of significance” is determined by comparing the average values of control with the measured groups. The results of measurements of the test group are also compared to the results of group D, whose function is to define the significance of the level of the subject's anxiety from being presented the test stimuli of Group C where mistake had been made. Based on the criteria of reliability, the qualitative characteristics of the uncovered significance are determined, i.e. the conditionality of the significance obtained with the semantic topic of the stimuli shown must be differentiated and confirmed.

The numbers of errors of different types are gathered and analyzed. Based on the character of the admitted mistakes using the standard rules, the psycho-emotional condition of the subject (degree of excitability or inhibitory blocks), and also his/her personal characteristics (attention span, memory, ability to learn) are defined. The personal characteristics may indicate an individual's mental fitness to respond when under psychological stress induced by the subconscious images and the testing conditions. Thus the test of such abilities can be essential to judging an individual's readiness to perform tasks under conditions of stress, such as in combat or other emergency situations in which emotional stress is severe. A report is finally generated which presents all the information once analyzed.

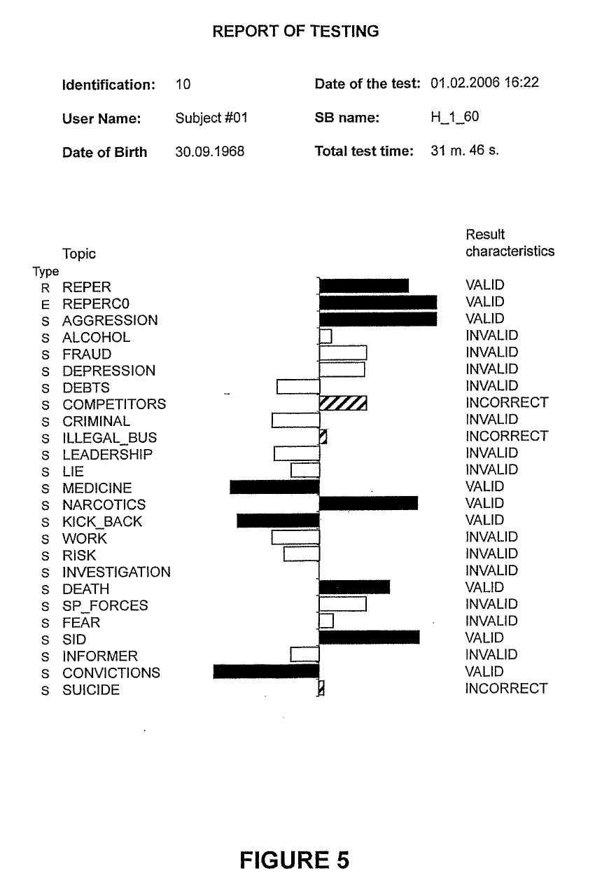

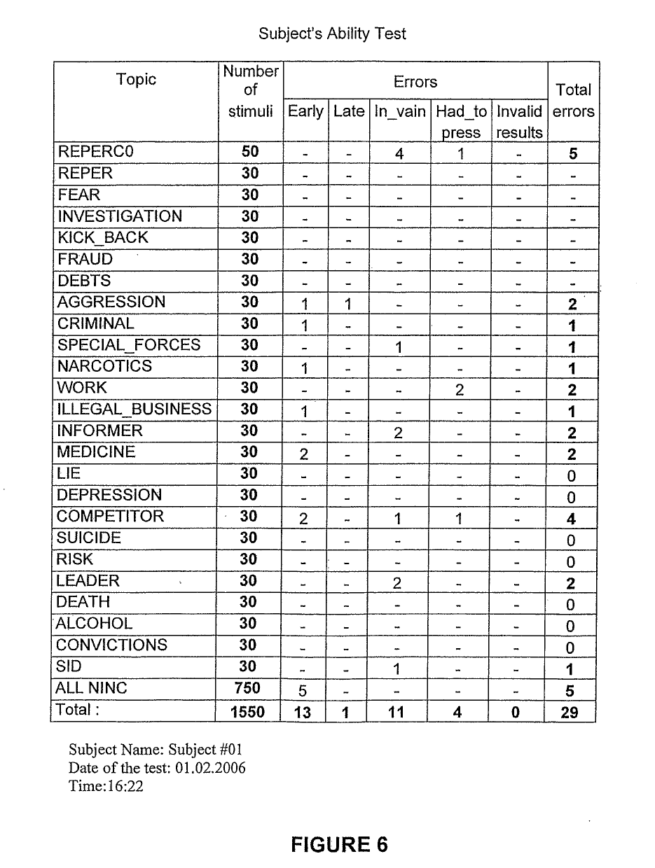

The controller/response analyzer may also provide a test report 60′. Reference will now be made to FIGS. 5 and 6, which present an example of a test report. Here below is an example of interpretation of this test report. The “invalid” mention means that these topics have no significance in the psyche of the subject being tested. The “incorrect” mention represents topics for which statistical analysis could not be performed and further testing is required to understand significance of these topics on the subject's psyche. Only the “valid” clusters are interpreted. The significant topics are the topics for which the subject had response times to the stimuli significantly different from his response times to control stimuli. In the present example, several topics show significant results in the test: aggression, medicine, narcotics, kick back, death, Sidney (SID) and conviction.
Aggression: It may be assumed of the presence of actual aspirations, or recent experience, of aggression in any form, or the presence of aggression at the time of testing.
Medicine: The results possibly indicate that the subject himself or someone very close to him is ill and requires medical assistance.
Narcotics: The results possibly indicate the presence of a hidden or concealable experience, or aspirations, where the subject was familiar with the usage of illicit drugs rather than distribution because the cluster “criminal” was not valid.
Kick-back: It is possible to draw a conclusion that the subject had subjectively significant experiences concerning a non-authorized commercial activity (kick back).
Death: It is possible to conclude that an urgent situation presently exists. It could be related to death or to funeral, either for the subject himself (he/she thinks about it) or for a person close to the subject. It could also mean the presence of a fatal illness. At the same time the cluster “suicide” was invalid.
Sidney: This topic reveals that the subject had a negative emotional attitude to the named person.
Conviction: It may be assumed that, for the subject, the situation connected with litigation and imprisonment is of a great emotional importance.

The test also evaluates the attitude of the subject to destructive motives. During testing it was established that there was no actual destructive motive toward alcoholism (topic “alcohol” invalid) and no hidden affective complexes, which could identify monetary liabilities (topic “debts” invalid).

The test further evaluates work activities. According to the test, the following topics of professional work were studied: attitude towards work and aspirations for leadership. The following results were: Subject had no negative attitude towards professional work (topic “work” invalid) and has no leadership aspirations (topic “leader” invalid).

Miscellaneous other topics are also evaluated. The test results show that the contacts with law enforcement agencies are described as invalid (topic “special forces” invalid). In parallel, no valid reactions were recorded when the subject was presented stimuli from the “criminal” topic. It may therefore be assumed of the absence of any past criminal experiences. Reactions of preference in the given topic are not revealed. It testifies to the absence of criminal intentions in the present as well.

Mistakes made by the subject during the test may also reveal important information. In the present example, a rather small quantity of errors (29 out of 1550 presented stimuli) testifies to the sufficient motivation of the subject. The time of the test procedure (31 minutes 46 sec.) does not exceed the average. Prevalence of errors such as pressing “EARLY” was larger then pressing “LATE”, which testifies to the readiness for mobilization of his internal resources to adapt to stressful situations. The subject exhibited a high level of wakefulness, dynamism and activity. The level of his activity testified to the absence of significant psycho-physiological problems.

Subject #01 possesses a high working capacity and stability under stress. He is capable of making important, critical decisions, being guided by logic and professional experience. He is well guided by the information provided and able to make optimum decisions in extreme situations. The subject is easily trainable and capable of optimizing his activities. His high level of self-control (few mistakes) was noted. He is counterbalanced and according to psycho-physiological parameters has advanced adaptability mechanisms.

This type of psychological test, called psycho-probing has many applications.

1. Medical and Psychoanalytic Practices.

The method may be used to uncover latent complexes, the reasons for intrapersonal and interpersonal conflicts. Stimulating material such as the names or images of people important in the life of the subject (parents names, their portraits), the descriptions of psychological trauma which could hypothetically start the mechanism of neurosis are used to search for “traces of affect”. All of this is done to find their subjective importance for the subject.

The method may also be used for testing the effectiveness of psychological/psychiatric treatments.

It may also be used for personality testing (modified “color test by Luscher”). The screen is filled with one of four primary colors. An interpretation about a subject's personality is revealed depending on which color has the most significance for the subject.

2. Human Resources Practice.

The method may be used to better know applicants for a position. The assessment of the applicant may include tests for alcoholism, narcotic usage or dependency, heavy debt, various family dynamics, money as an exclusive motivation, association with criminal groups, terrorism. Each of these topics can be presented as combinations of words or images, which are shown as stimuli according to a designated algorithm.

The method could also be used to monitor the psychological climate in a company, identifying potential leaders, uncovering incompatibility of some subjects with the rest of the employees, identifying employee's attitudes toward management etc. In these cases, material used for the stimuli are photos of employees, their names, nicknames etc.

3. Security Services

The method may be used to investigate business counterintelligence or to investigate employees' attitude towards competitors. Portraits of competitor's managements, their names, trademarks of the competitor's company may be used as stimuli.

The method may also be used to evaluate trustworthiness. This is an evaluation of different kinds of business risks such as using the company's position for personal gains, stealing from the company when the employee is burdened by heavy financial debt, associating with criminal organizations, etc. For evaluation of these topics the selection of the chosen material for stimuli is similar to the material used for Human Resources test.

The method may further be used for work place investigations. Stimuli may represent images of objects or verbal identifiers of the objects which form the basis of the investigation. These identifiers need only be known to the offender (the phenomenon of “guilty knowledge”).

Another area of use is counterintelligence for criminal intention. This is related with the protection of special objects such as mass transportation, atomic power plants, etc. Stimuli may be images of weapons, explosives, portraits of possible terrorist perpetrators.

4. School Environment

The method may be used to investigate the true preferences of students for future professions. Each profession is represented by the list of words with which the given profession is associated. The true preference of the student can differ from the declared preference, which may be influenced by a social role, pressure from parents, peers etc.

The method may also be used to help a school psychologist detect critical family situations in a timely fashion when a child chooses to hold back information. Depression, drugs, alcohol, suicidal tendencies, bullying, or being bullied can all be identified.

5. Marketing Research

The method may be used to evaluate the messages being delivered to the customers through different advertising venues including the public's response to the company's product, company's image (such as slogan, logo or the motto of the company, trademark graphics, elements of company's style etc.). It is analogue to surveying, but without the numerous unknown factors which influence the state of mind of each person from the surveyed population.

The following represent an example of use of the present invention for the optimization of diagnosis and treatment of Post-traumatic stress disorder (PTSD) using an artificial neural network.

It is a well known fact that the majority of war combatants tested have experienced significant stress overloads. According to some authorities, 15%-25% of military personnel returning from combat zones show evidence of PTSD which as a rule, are evidenced by dependences on alcohol, narcotics, gambling or other severe behavioral abnormalities/addictions.

One of the most modern directions for diagnosis and treatment of these conditions is psycho semantic probing of the subjects mind and psycho semantic correction in subconscious presentation of words/stimuli.

The standard technique of psycho probing used nowadays in testing the subconscious mind is with the fixed time exposure of stimuli. However, the degree of perception in people is varied and depends on the age of the subject, psychological condition as well as other factors. Therefore, the time of exposure for the subconscious mind to the stimuli should be individually attuned.

The present trend is to use the artificial intelligence computer technologies which are in use in every day medical practices. The current methods are based on elements of the computer program which anatomically models the neural network of the human brain. Therefore, the method is referred to as the artificial neural network (ANN). Neural networks resemble the human brain in the following ways:
A neural network acquires knowledge through learning.
A neural network's knowledge is stored within inter-neuron connection strengths known as synaptic weights.
   The basic properties of the neuronal network are:
an extraction of knowledge from the given set of information (training mode);
absence of restrictions on the character of the information being entered without postulation of aprioristic reasons;
accumulation of knowledge during the mode of self-training;
finding dependences between the obtained data;
using accumulated knowledge for making a decision within the applied task (performance mode);
ability to make decision based on incomplete, distorted or “noisy” information;
use of the software in personal computers without any additional equipment;

For an evaluation of a subject's current psychophysiological condition, degrees of susceptibility and ability of nervous system, a known technique of an estimation of time of critical frequency of merges-flashings (CFMF) was applied.

The following instruction was given to each subject being tested: “some features of your vision will be now investigated. Please, put your preferred hand on the mouse, forefinger on the left button, press it. The frequency of flashings will start to increase. When the flashes merge (both half of the computer screen are equally lighting up), press the button of the mouse. Continue to observe the screen and when you see the repeated occurrence of flashings merging (during gradual reduction of their frequency) again press the button of the mouse and then stop observing the screen.” The task is considered completed if both fixed frequencies do not differ more than on 3-4 Hz. Otherwise the process is repeated again.

“ANN”, which is part of an overall software package, consists of multilayer perception. This type of neural network is known as a supervised network because it requires a desired output in order to learn. The goal is to create a model that correctly maps out the input to the output using historical/experimental data so that the model can then be used to produce the output when the desired output is unknown.

“ANN” learns using an algorithm called backpropagation. With backpropagation, the input data is repeatedly presented to the neural network. With each presentation the output of the neural network is compared to the desired output and an error is computed. This error is then fed back (backpropagated) to the neural network and used to adjust the weights such that the error decreases with each iteration and the neural model gets closer and closer to producing the desired output. This process is known as “training”.

During “training”, fine tuning of key parameters of the neural network occurs by means of genetic optimizer. Genetic algorithms are based upon the principles of evolution observed in nature. Genetic algorithms combine selection, crossover, and mutation operators with the goal of finding the best solution to a problem. Genetic algorithms search for this optimal solution until specified termination criterion is met.

To attain the required goal, a special program complex called “SSRM tec Plus” is used. It includes three modules: the module for an estimation of current psycho physiological state—CFMP, the module for the random presentation of words stimulus in 10 experimental modes (from 5 up to 50 msec. with 5 msec. steps) for data acquisition and training of “ANN” and the module to use the trained “ANN”, which allows (based on CFMF time, subject's age, sex and investigation time) to determine the specific effective subconscious exposure time period for the subject.

In the module with a random subconscious presentation of words stimulus, three groups of words are used. The first group consists of words which would be indifferent to the subject being tested and therefore there would be no reaction. In the second group, the words have a connection to a name of the subject being tested and a positive reaction is always registered. The third group, so-called, “Reper”, uses words for which a negative reaction of the subject is developed. To obtain a subject's effective subconscious exposure time period the presentation of words—stimulus, each word is presented to the subject in a subconscious mode 30 times for each experimental mode. The subject's effective subconscious exposure time period is considered to be the peak of Student's coefficient which reflected the statistical significance in speed of the reaction of the subject to the subconscious presentation of words from group “NAME” and “Reper” against the group of indifferent words.

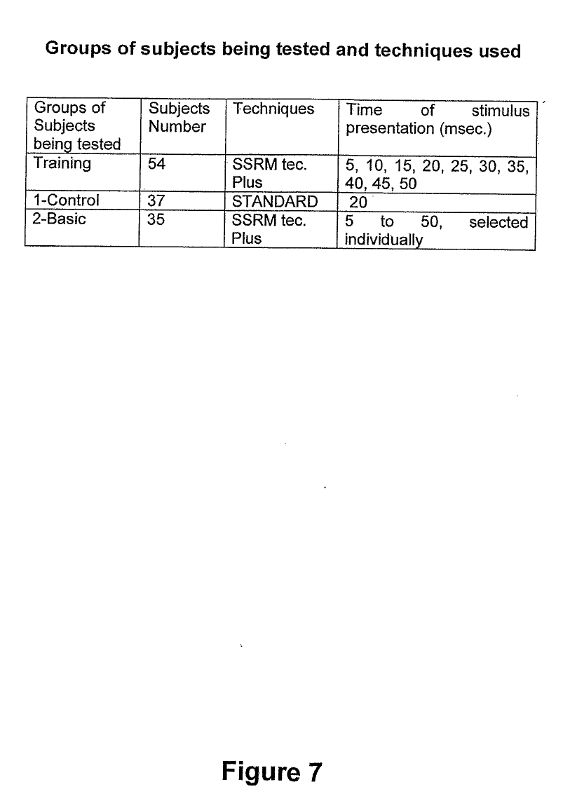

126 war veterans with the average age of 34.1+3.2 years were tested and treated. All of these military personnel received medical treatment in psychoneurological branch of the Central hospital for various post-traumatic disorders. 54 subjects were randomly assigned to a training group for “ANN”. The others were randomly divided into 2 groups. 37 subjects in the first group (controls) were diagnosed using standard subconscious semantic response measurement technique and treated using correction technique, both techniques had fixed time for the presentation of words—stimulus (20 msec.). 35 subjects of the second group (basic), were diagnosed and treated using a special program complex “SSRM tec Plus” with neural network definition of the effective subconscious exposure time period on the basis of an estimation of time of critical frequency of merges-flashings (CFMF), age of the subject, sex and time of testing. See FIG. 7. For statistical analysis programs STAT6, StaSoft were used.

Experimental modes for each subject of training group is used to obtain a distribution curve for Student's coefficient which depends on the time of subconscious presentation of words-stimulus. The example of the dependency graph of the Student's coefficient of the subject “A” with peak at 15 ms (effective subconscious exposure time period) as is shown on FIG. 2.

The Student's coefficient equal in this case 3.5, testifies to the presence of “window in the subconscious mind” during the presentation of words-stimulus with the duration of 15 ms when the word presented subconsciously, and its influence/response is maximum.

Results of the effective subconscious exposure time period for subjects in the training group, together with the CFMF results of the technique and individual characteristics of the subjects, such as age, sex, time of testing is the data on which “ANN” was trained. As a result of training an “ANN” program, a complex “SSRM tec Plus” was developed, which on the basis of CFMF time and individual characteristics of the subject is capable of determining “a window in the subconscious mind” of effective subconscious exposure time period with a factor of correlation r=0.93, p<0.01.

The efficiency of “SSRM tec Plus” complex with the speed of the consolidation of stimuli in subconscious mind of the subjects was compared to the standard variant of time presentation of stimulus. Due to the usage for psycho semantic probing and treatment by the program complex “SSRM tec Plus”, consolidation of stimulus occurred, on the average, within 6.3 sessions. That, that is 1.75 times faster (p<0.01) than a standard technique which required, on the average, 11.0 sessions.

Positive result has been achieved in all subjects of the second group, whereas in the control group the positive result of treatment has been achieved in 31 out of 37 subjects. It was concluded that the objective reason of negative results at 6 subjects was the wrong choice of fixed time of presentation of stimulus.

The results of the tests illustrate the presence of a phenomenon of “recognition without comprehension”, confirming the fact that the human mind represents a uniform conscious-unconscious contour of processing of the information and management, separate parts of which possess the relative autonomy of carrying out the important role in complete mental self-organizing.

For each subject with given psycho-physiological condition exists an effective subconscious exposure time period that is necessary to take into account for increasing the efficiency of the techniques working in a subconscious arena.

The person skilled in the art will appreciate that the most effective subconscious exposure time period may not, in reality be the exact most effective subconscious exposure time period for a person. Indeed, because the images are shown using a computer screen, the precision of the determination of the most effective subconscious exposure time period is limited by the physical limitations of the screen, in particular its refresh rate. For example, if the highest refresh rate of a screen is 200 Hz, the smallest time period than an image remains on a the screen is 5 ms. Hence, if a subject's most effective subconscious exposure time period is not a multiple of 5 ms, for example 13 ms, it will be impossible to find it by sticking to the fastest rate. However, it may be possible to use only one multiple of a slower rate to get closer to such an exposure time. For example, 75 Hz would yield an exposure time of 13 ms, permitting to find the effective subconscious exposure time of the subject in this example. For screens using an interlaced mode, one refreshing cycle of only one field of the screen could be used. In any case, it is recommended to use a screen with the fastest refresh rate possible.

Furthermore, the person skilled in the art would recognized that the most effective subconscious exposure time period of a subject may vary from one day to another, depending on many factors such as exhaustion, stress, sickness, etc. Hence, what is deemed as being the most effective subconscious exposure time period at a given moment may be different at another moment. Furthermore, the methods can be adapted to the specific psychological profile of a subject.

It will be appreciated that the present invention could be implemented in many ways. For example, a subject may be tested by being presented visual stimuli through a heads-up display system (for example, integrated to his glasses) that he/she is wearing. At the same time, the brain activity of the subject is monitored (by using electrodes, for example). Reactions to stimuli show in the brain activity of the subject and are registered in a computer for analysis.

The method described herewith may also have different embodiments with regards to where each step is performed. For example, it is possible to just gather the information about the reactions of the subject and have the calculator perform the analysis of the responses at a later time. It is even possible to have this analysis performed by a third party.

In the present description, the terms “word” and “image” were used to distinguish a word that is displayed on a screen from an image having no letters displayed on a screen. However, the person skilled in the art will appreciate that a word displayed on a screen is indeed an image (anything displayed on a screen is an image) and that indeed, the present invention work as effectively with any type of image displayable on a screen.

The present invention has been described with regards to preferred embodiments. The description as much as the drawings, were used to help the understanding rather than to limit the scope of the invention. It will be obvious to one skilled in the art that several modifications or variations may be brought to the invention without departing from the scope of the invention as described herein and are intended to be covered by the present description.

1. A method of psychologically testing or subconsciously teaching a subject comprising:
exposing the subject to an effective number of visual subconscious stimuli, same or different, displayed at different subconscious exposure time periods, wherein the different subconscious exposure time periods permit greater efficiency of testing or teaching than a single subconscious exposure time period.

2. A method as defined in claim 1 further comprising:
determining a reaction of said subject to said visual subconscious stimuli and analyzing said subject's reaction to said visual subconscious stimuli to determine a desired effective subconscious exposure time period specific to the subject.

3. A method as defined in claim 2 wherein a profile of the subject is used in one or more of: selecting values for said different subconscious exposure time periods; and said analyzing said subject's reaction to determine said desired effective subconscious exposure time period.

4. A method as defined in claim 2 further comprising exposing the subject to additional visual subconscious stimuli, same or different, displayed at said effective subconscious exposure time period for a remainder of said psychologically testing or subconscious teaching.

5. A method as defined in claim 4 wherein said method is repeated with a second subject, said effective subconscious exposure time period being different for said subjects.

6. A method as defined in claim 5 wherein said effective subconscious exposure time period is determined to maximize said subject's reaction.

7. A method as defined in claim 2, wherein said reaction is determined by comparing subject response to subconscious visual stimuli having a high semantic load with subject response to subconscious visual stimuli having a low semantic load.

8. A method as defined in claim 7, wherein said subconscious visual stimuli having a low semantic load have essentially no semantic load.

9. A method as defined in claim 2 wherein said different subconscious exposure time periods comprise at least five periods in the range of 9 ms to 25 ms.

10. A method as defined in claim 7, wherein said reaction is determined by measuring a deviation in said subject's voluntary response time to a conscious stimulus as a function of exposing said subject to said subconscious visual stimuli.

11. A method as defined in claim 10 wherein said conscious stimulus contains visual information for the subject's analysis to indicate a type of suitable voluntary response, said reaction being determining by said response time deviation and by errors in said suitable voluntary response made by the subject.

12. A method as defined in claim 7, further comprising:
masking said visual subconscious stimuli with a masking stimulus.

13. A method as defined in claim 12 wherein said visual subconscious stimulus and said masking stimulus have substantially similar image characteristics comprising brightness and contrast.

14. A method as defined in claim 13 further comprising:
selecting said visual subconscious stimulus from a group of subconscious stimuli; and
selecting said masking stimulus from a group of masking stimuli, wherein said group of subconscious stimuli and said group of masking stimuli are contained in a database.

15. A method as defined in claim 13 wherein said subconscious exposure time period ranges between 5 milliseconds and 50 milliseconds.

16. A method as defined in claim 13 wherein said masking stimulus is a scrambled version of said visual subconscious stimulus.

17. A method as defined in claim 16 wherein said masking stimulus consists essentially of a plurality of subcomponents of said visual subconscious stimulus, said plurality of subcomponents being arranged randomly.

18. A method as defined in claim 1, wherein said exposing comprises adjusting said subconscious exposure time period by varying a refresh rate of an electronic display and displaying said visual subconscious stimulus for at least one field or frame of said electronic display.

19. A method as defined in claim 1, wherein said exposing is done by varying a number of fields or frames during which said visual subconscious stimulus is displayed on an electronic display operating at a refresh rate of at least 200 Hz.

20. A method of psychologically testing or subconsciously teaching a subject comprising:
exposing the subject to different masking stimuli following different visual subconscious stimuli to obtain a reaction from the subject, each said visual subconscious stimulus and said following masking stimulus having substantially similar image characteristics comprising brightness and contrast.

21. A method as defined in claim 20 wherein said masking stimulus is a scrambled version of said visual subconscious stimulus.

22. A method as defined in claim 21 wherein said masking stimulus consists essentially of a plurality of subcomponents from said visual subconscious stimulus, said subcomponents being arranged randomly.

23. A method as defined in claim 22 wherein said subcomponents are further individually randomly rotated.

24. A method as defined in claim 23 wherein said subcomponents are of regular geometric shapes.

25. A method as defined in claim 24 wherein said subcomponents are hexahedrons.

26. A method as defined in claim 25 wherein said hexahedrons are individually randomly rotated by multiples of 60 degrees.

27. An apparatus for psychologically testing a subject comprising:
a controller operative to send visual subconscious stimuli at different subconscious exposure time periods to a display;
a display connected to said controller and operative to display said visual subconscious stimuli to the subject;
a reaction measurement unit operative to determine the subject's reaction to said visual subconscious stimuli;
a calculator connected to said reaction measurement unit and operative to determine an effective subconscious exposure time period specific to the subject.

28. An apparatus as defined in claim 27 wherein said calculator determines said effective subconscious exposure time period to maximize said reaction.

29. An apparatus as defined in claim 27 further comprising a response analyzer operative to compare said reactions to the display of said visual subconscious stimuli having a low semantic load with said visual subconscious stimuli having a high semantic load.

30. An apparatus as defined in claim 29 wherein said controller is operative to further send conscious stimuli following said subconscious stimuli, said reaction measurement unit being operative to receive input from said subject in response to said conscious stimuli, a variation in a response time being used by said reaction measurement unit to determine said subject's reaction to said visual subconscious stimuli.

31. An apparatus as defined in claim 29 further comprising a mosaic generator operative to generate a masking stimulus from each of said visual subconscious stimuli, said visual subconscious stimulus and said masking stimulus have substantially similar image characteristics comprising brightness and contrast.

32. An apparatus as defined in claim 29 wherein said controller executes a test script using said effective subconscious exposure time period once determined by said calculator.

33. An apparatus as defined in claim 31 wherein said masking stimulus is a scrambled version of said visual subconscious stimulus.

34. An apparatus as defined in claim 33 wherein said mosaic generator generates said masking stimulus by decomposing said visual subconscious stimulus in a plurality of subcomponents, said plurality of said subcomponents being arranged randomly.

35. A system for psychologically testing or subconsciously teaching a subject comprising:
a controller operative to send a masking stimulus and a visual subconscious stimulus to a display;
a display connected to said controller and operative to display said visual subconscious stimulus and said masking stimulus to the subject;
a mosaic generator operative to generate said masking stimulus from said visual subconscious stimulus.

36. An apparatus for psychologically testing a subject comprising:
a controller operative to send a visual subconscious stimulus to a display;
a display connected to said controller and operative to display said visual subconscious stimulus and said masking stimulus to the subject;
a reaction measurement unit operative to determine the subject's reaction to said visual subconscious stimulus;
a response analyzer operative to evaluate errors in a suitable voluntary response made by the subject to determine an indication of a degree of fitness to respond under psychological stress for the subject.

37. A method of psychologically testing a subject using measurement of a deviation in the subject's voluntary response time to a conscious stimulus as a function of exposing the subject to a subconscious visual stimulus, said conscious stimulus containing visual information for the subject's analysis to indicate a type of suitable voluntary response, said reaction being determined by said response time deviation and by errors in said suitable voluntary response made by the subject, the method comprising:
evaluating said errors to determine an indication of a degree of fitness to respond under psychological stress for the subject.

38. A method as defined in claim 37 wherein said errors are weighted more for errors made following a visual subconscious stimulus having low semantic load.
